(19) United States
(12) Patent Application Publication
(10) Pub. No.: US 2004/0019562 A1
(43) Pub. Date: Jan. 29, 2004

(54) Term allowance clearinghouse

(76) Inventor: Jon Jay Viberg, Orland Park, IL (US)

Correspondence Address: Faier and Faier, P.C., 566 West Adams Street, Chicago, IL, 60661, US

(21) Appl. No.: 10/452,548

(22) Filed: Jun. 2, 2003

Related U.S. Application Data
(60) Provisional application No. 60/384,398, filed on Jun. 3, 2002.

(51) Int. Cl. G06F 17/60

(52) U.S. Cl. 705/40

(57) ABSTRACT

The present invention provides a method or system of commercial financing, whereby the buyer, the seller and a putative funding entity enter into a standardized agreement capable of creating an irrevocable commercial instrument between the buyer and the seller as consideration for the seller to deliver goods and/or services to the buyer. Such an instrument would authorize presentation of the instrument by any holder of the instrument at the buyer's bank at a specified date for a specified amount. In other words, the instrument would be negotiable, and the seller could tender the instrument in an open market to obtain the most competitive price for the instrument from a holder. Under the standardized agreement, any holder of the instrument would be able to present the instrument free of any commercial dispute between the buyer and the seller. In another embodiment, a financial intermediary provides a standardized agreement, and a forum for negotiating, creating, and clearing dated financial instruments. In a further embodiment, the forum is an electronic forum accessible through the internet.

### PRIORITY CLAIM

The present application claims benefit of priority from U.S. provisional patent application 60/384,398 filed Jun. 3, 2002, which is incorporated by reference, herein.

### FIELD OF THE INVENTION

The present invention provides a method and system to create and transact negotiable commercial trade instruments.

### BACKGROUND

Some commercial transactions are driven by financing based upon an assessment of the credit-worthiness of the parties to the transaction. For example, when a business entity seeks to obtain financing for purchasing equipment or inventory, the business entity may seek a loan from a funding entity. The funding entity will assess the credit risk posed by the business entity, and determine whether or not to provide the loan, and if so, the cost and terms of the loan. The funding entity may require the loan to be secured by a collateral, such as the accounts receivable, inventory or other assets of the business entity. The collateral is generally secured by perfecting a lien against the collateral. Such a process is cumbersome and expensive.

As another example, when a buyer purchases goods or services from a seller, the amount owed to the seller by the buyer upon delivery of the goods can be remitted immediately or can be remitted later as the seller's account receivable. The seller's tolerance for delayed payment by the buyer is based upon the credit-worthiness of the buyer, the seller's ability to risk default by the buyer, and the seller's need for capital. If the seller cannot wait for payment, and the buyer cannot pay upon delivery, the seller may decide to sell the account receivable to a funding entity. The funding entity would assess the credit risk posed by the buyer and the seller to determine whether or not to purchase the account receivable, and at what discount. In the latter example, if there is a default by the buyer, or if the seller delivers poor quality goods, the ability of the funding entity to recover its funds may depend on separate contractual relationships between the seller and funding entity, and between the seller and the buyer. The complex web of relationships creates added commercial risks that drive up the cost of the transaction. Moreover, an acceleration in the speed of commercial transaction in the global economy and in e-commerce also makes risk evaluation of commercial financing less certain, and therefore more expensive.

U.S. Pat. No. 5,694,552 disclosed a financing method in which the seller in a commercial transaction enters into an agreement with a financial institution for the disposition of trade acceptance drafts created by the commercial transaction. Further, the seller enters into another agreement with a buyer, in which the commercial transaction is contingent upon the buyer being pre-approved by the financial institution. If the buyer is pre-approved by the financial institution, the seller prepares a trade acceptance draft for the seller to collect the value of the transaction at a specified date at a specified bank. If the goods or services are accepted by the buyer, remittance of the draft is authorized by the buyer, and the draft is transmitted to the seller. Then, the seller endorses the draft and tenders the draft to the financial institution for purchase as a holder-in-due course in accordance with agreement between the financial institution and the seller.

U.S. patent application Publication 2002/0046172 generally discloses the concept of generating an electronic draft by registering makers and owners, and creating an electronic draft and assigning an unique identification number to the draft. The draft can be endorsed by a first owner to subsequent owners. On the due date of the draft, the system collects funds from the designated bank and transfers the funds to the last identified owner. It would be desirable to create a method and system in which the credit-worthiness of buyers and sellers are pre-evaluated and transparent, such that the value of a commercial transaction between a particular seller and a particular buyer is easily assessed by potential funding entities in an open market for financing purposes.

### SUMMARY OF THE INVENTION

The present invention provides a method or system for commercial financing, whereby the buyer, the seller and a putative funding entity enter into a standardized agreement. The agreement provides terms under which the buyer can make an irrevocable commercial instrument payable to the seller as consideration for the seller to deliver goods and/or services to the buyer. Such an instrument would authorize presentation of the instrument by any holder of the instrument at the buyer's designated bank at a specified date for a specified amount. In other words, the instrument would be negotiable, and the seller can post the instrument in an open market to obtain the most competitive price for the instrument from a holder. Under the standardized agreement, any holder of the instrument would be able to present the instrument regardless of any commercial dispute between the buyer and the seller.

In another embodiment, a financial intermediary provides a standardized agreement, and a forum for negotiating, creating, marketing and settling dated financial instruments. The standardized agreement is executed by the buyer, the seller and all putative holders. Under the method and system, all terms, representations and warranties of each party are understood by the other parties, since all are signatories to the same agreement. This standardization provides the capacity for the sellers and buyers to enter into commercial transactions by making irrevocable, commercial, negotiable instruments in which the date, amount and place of remittance are specified. Moreover, financial commitments and pre-approvals between the seller and funding entities are not necessary, since the method provides for a pre-evaluation and a transparency of the financial health of the parties to the transaction that can be used by multiple putative holders in assessing the value of the instrument. In another embodiment, the standardized agreement provides for a financial intermediary that serves in an administrative capacity, and is not a party to any transaction arising therefrom, except in that capacity. In a further embodiment, the forum is an electronic forum accessible through the internet.

In another embodiment, the financial intermediary uses the risk factors of the parties of a commercial transaction to assign a risk value to a transaction, then matches the risk value to the risk tolerance of holders to notify holders that financial instruments that match their risk criteria may be available for purchase, either on a recourse or non-recourse basis. In a further embodiment, the invention allows the parties to a commercial transaction to manage risk and reduce the cost of doing business, by providing financial resources to buyers and sellers through the matching of the risk of the transaction to the risk tolerance of a large number of potential funding sources.

### BRIEF DESCRIPTION OF THE FIGURES

FIG. 1 is a schematic representation of a system for enrolling participants, and creating and marketing drafts.

FIG. 2 is a schematic representation of a process for a participant to enter the system.

FIG. 3 is a schematic representation of a process for enrolling different categories of participants.

FIG. 4 is a schematic representation of a process for creating a draft.

FIG. 5 is a schematic representation of a process for a seller to market the draft to holders, wherein the holders can have input as to the terms for the transfer of the draft.

FIG. 6 is a schematic representation of a process for the transfer of funds and draft between the holder and the seller.

### DETAILED DESCRIPTION

The invention is described by the following examples. It should be recognized that variations based on the inventive features disclosed herein are within the skill of the ordinary artisan, and that the scope of the invention should not be limited by the examples. To properly determine the scope of the invention, an interested party should consider the claims herein, and any equivalent thereof. In addition, all citations herein are incorporated by reference.

The present invention provides a method and system for negotiating, issuing and settling commercial trade negotiable financial instruments. In accordance with the method, participants (buyers, sellers, and holders) in the method or system enter into a standardized agreement to issue dated commercial trade financial instruments (hereinafter “drafts”). This standardized agreement may also be referred to as a Term allowance Participation Agreement or the Tri-party Agreement. The terms and definitions of the standardized agreement provide that the participants consent to the making, endorsing, negotiation and clearing of the drafts under the Uniform Commercial Code (UCC). Relevant sections of the UCC may include Articles 2, 3, 4 and 8, more specifically 3-201 to 204, 3-301 to 306, 3-401, 407, 409 and 413 relating to negotiation, subject to rescission, transfer, indorsement and entity to enforce, holder in due course, value and consideration, overdue instrument, defenses and claims to instrument and signature, alteration, acceptance of draft, obligation of acceptor and obligation of indorser. In this manner, each buyer, seller and holder understands the representations and warranties of the other participants under the standardized agreement. Thus, draft issuance is standardized by an agreement that integrates one or more third party holders to fund the commercial transaction between the buyer and the seller.

In the context of this invention, buyers are purchasers of goods and/or services who will make a negotiable instrument (a draft) for payment for the value of the goods and/or services at a later date at a specified financial institution, such as a bank. Herein, sellers are provider of goods and/or services that will accept the negotiable instrument from the buyer. It is noted that sellers are, in fact, the initial holder or the instrument, but herein will be “sellers” for ease of reference. In the context of this invention, holders are actually subsequent holders that may acquire the instrument from the seller or other holders. Although holders are actually putative holders until they acquire the instrument and former holders after they sell the instrument, for ease of reference, herein they are “holders” before they acquire the instrument, and after they relinquish the instrument. Herein, draft owners are holder or sellers that possess a draft, and draft buyers are all holders that purchases a draft. In general, holders are financial institutions such as banks, asset-based lenders, credit insurers, corporations, investment funds, or other funding entities who are willing to purchase the instrument at a value discounted to reflect the risk of default of the instrument and the cost of capital. Unless otherwise indicated, buyers, sellers and holders refer to participants who have executed the standardized agreement (i.e., registered participants). A single commercial entity can participate as any one, two or all three of the categories of buyers, sellers and holders by executing the appropriate section of the standardized agreement.

The system and method allow sellers, buyers and holders to participate in commercial trade financing, by creating an irrevocable commercial negotiable instrument and setting the terms of the participation. Since a market mechanism will determine the risk and value of the instrument, and since the transactions are governed by a standardized agreement, the invention provides a broader array of funding opportunities for the seller to find the most efficient cost of capital, and dispenses with the financial commitments and pre-approvals required when the seller deals with a single funding entity. In other words, the method and system provides the capabilities of a commercial risk trading platform. Moreover, the transparency of the system (the ability to determine the buyer and seller's size, years in business, industry, credit history, etc.) provides sellers and holders a ready platform to assess the risk of non-payment in a commercial transaction. This transparency reduces trade risk, and provides greater certainty as to the extent of risk and increases the value of the draft. Significant savings are achieved when risk is easily determined, and the cost of financing can be distributed between the seller, buyer and holder. Benefits of the method and apparatus include lower buyer costs, transparency of the sellers sales, costs and profits, reduced commercial risk and increased flexibility in sourcing working capital.

When determining the discounted value of the draft, a registered holder would have, by executing the standardized agreement, understood the nature of the asset, and the commitments, promises and warranties of the various participants regarding such an asset. Accordingly, the holder is able to price the asset according to the net present value discounted according to the holder's expected return on capital. When the holder is informed of the availability of a draft, either physically or electronically (e.g. by e-mail), the holder can determine whether the draft fits the holder's risk criteria, and if so, offer a discounted value for the asset. The holder understands that other holders may also offer to purchase the draft, and that the seller may either accept the highest offer or refuse all offers as insufficient. The holder may also participate in setting the terms of the transfer of the draft (e.g. requiring sale of the asset as recourse when the asset is offered as non-recourse).

Optionally, the agreement provides for a forum or a clearing house, wherein the seller can market drafts to the holders to obtain the highest purchase price for their drafts. This creates a liquidity market wherein the seller can present the draft to a number of funding entities. By contrast, prior sales of account receivables are generally negotiated between a single seller, and a single funding entity. Even if the seller shops the transaction, he will have contacted, at most, a handful of funding entities. The present invention provides a competitive access to working capital for the seller, and enables the seller to access securitization, and risk derivative markets to reduce trade risk. In a further embodiment, the agreement is provided and managed by a financial intermediary, that optionally provides the forum or clearing house. In a another embodiment, the drafts are standardized under UCC Article 8, section 8-105 as Certificated Securities.

In a further embodiment, enrollment and participation is accomplished electronically in a virtual environment, such as one called eTACH (electronic Term Allowance Clearinghouse). Herein, a system comprises memory storage device, a database, a processor and a communication portal that is electronically accessible by users. Optionally the system also has a risk matching assessment system and/or a risk matching notification system. The database houses relevant financial data that have been entered by the participants, such as credit rating, recourse and non-recourse credit lines and credit availability. Optionally, the manager of the system verifies such data. Such data is capable of being matched to the credit criteria of the holders, so the holders can be notified when drafts of interest are available. Further, the system provides for the making, negotiation and settling of the drafts, wherein such activities are entered into the database as appropriate transfer books (tracking the creation, negotiation, and subsequent presentation), with the appropriate draft identification. Such drafts can be in hard copy or electronic form, and can be physically or electronically forwarded through the banking system for collection from the bank account designated by the buyer.

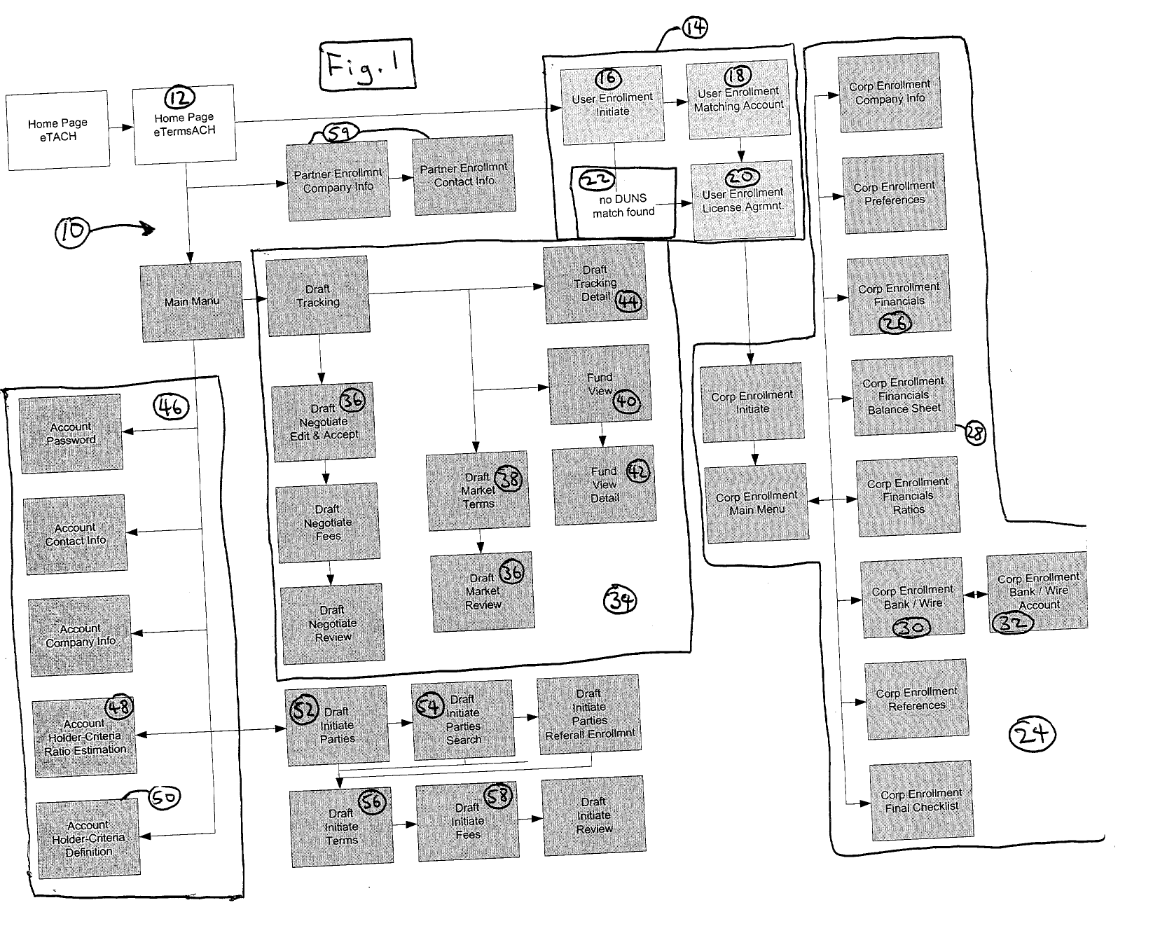

FIG. 1 illustrates an electronic forum wherein putative participants can enroll in the system, and enrolled participants can make and negotiate drafts, and holders can access financial information on the sellers and buyers of interest. When an user enters the system 10, the system inquires whether or not the user was previously enrolled and has an account 12. If the user does not have an account, the user initiates the enrollment process 14, wherein the user is asked for user identification information, and the Dun and Bradstreet identification (DUNS) of the user's company 16. If the DUNS matches an enrolled company, the user is enrolled as a user 18 and is asked to execute the user enrollment license agreement 20. This terminates the user enrollment initiation, and when the user is validated, the user is allowed to access appropriate sections of the remainder of the forum (depending on the user category, as buyer, seller or holder).

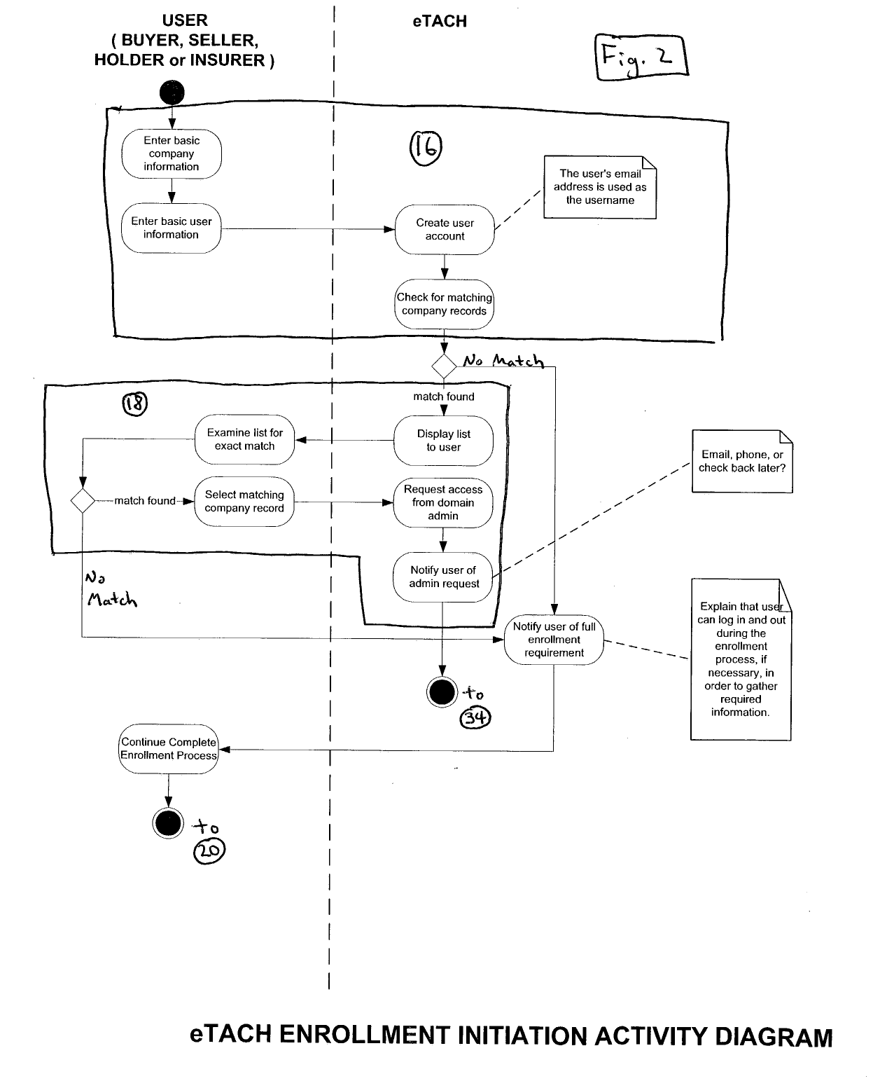

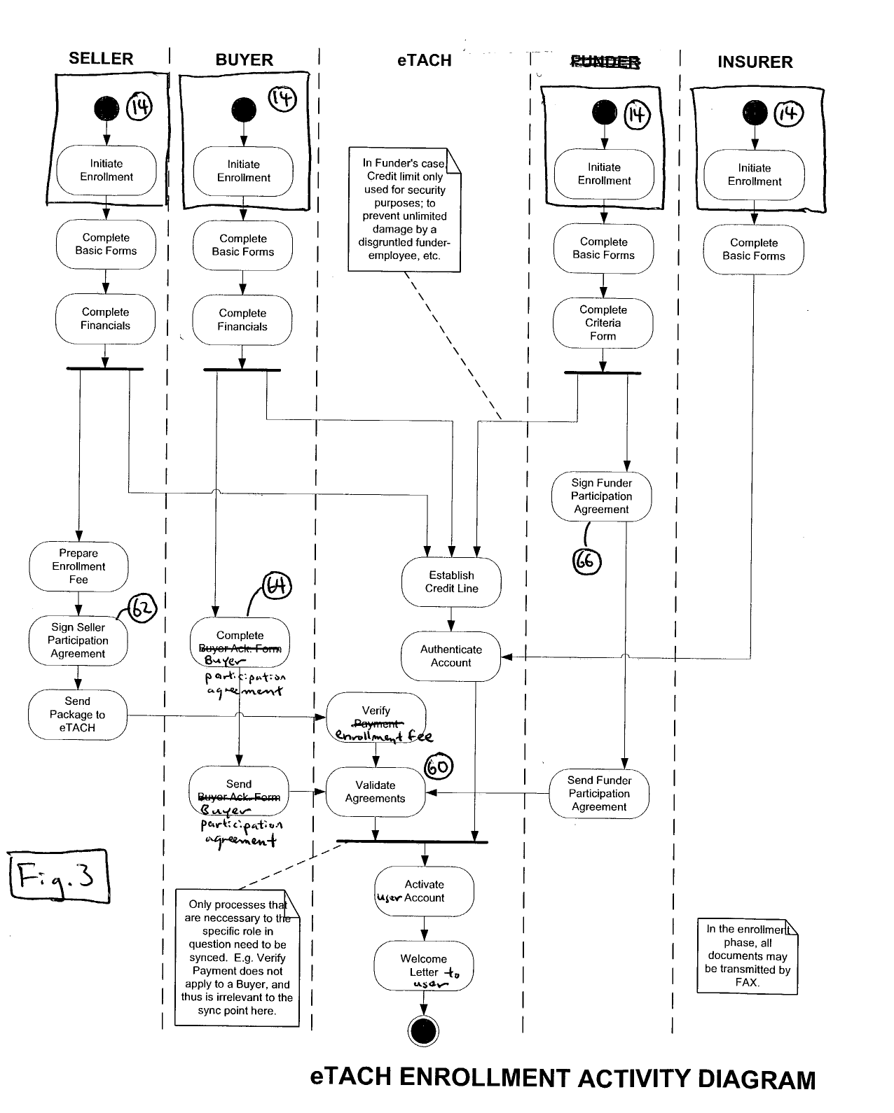

If the DUNS does not match an enrolled company, the user is asked to execute the user enrollment license 20 and to enter the relevant company information, which includes information such as financials 26, balance sheet 28, designated bank 30 and bank wire account 32. Once the appropriate company information is entered and validated, the user is allowed to access appropriate sections of the remainder of the system. Optionally, the information is scored to determine a preliminary commercial risk for the purpose of matching any drafts made or held by the user to holders seeking drafts that fit the risk criteria. In this embodiment, buyers and sellers must enroll, while holder are only encouraged to enroll. However, the system can be set up to require enrollment of all participants. While the DUNS is shown in this embodiment, other identifiers may be used to determine whether or not an user's company is already enrolled. The enrollment initiation details are illustrated in FIG. 2. Details of the enrollment are illustrated in FIG. 3 showing the enrollment steps for sellers, buyers, holders, and optional insurers. Since the funding entities usually underwrite the transactions, the insurers are usually not involved. However, for particularly large or risky transaction, the funding entities may require insurance to reduce the risk. Note that validation of the enrollment 60 includes validating that the seller, buyer and holder have execute their section of the standardized agreement (see 62, 64 and 66). In addition, for the buyer, the enrollment is validated by verifying the bank on which the draft will be drawn. Once the user's enrollment is verified, the user's account is activated, and the user is welcomed into the system. Thereafter, the user may use the system according to the terms of the standardized agreement, as long as the user's account remains open.

If the user is a buyer or seller, enrollment will include executing the buyer or seller section of the standardized agreement, respectively. The enrollment is validated by a financial intermediary, who may or may not be a party to the standardized agreement. Optionally, a Dun and Bradstreet report and credit check is incorporated into the validation. Presently, holders are encouraged, but not required to provide company information. However, in order to participate, they must execute the holder section of the standardized agreement. Optionally, they may be required to identify a bank from which funds can be drawn for the purchase of the drafts.

If the user has an account, the user may, by entering the appropriate password for the account, access the draft tracking section of the system 34. Within the draft tracking section 34, the user can participate in making a draft 36; post a draft in the market for sale to holders 38, determine the terms of such sales 36; track the amount of funds offered for the draft 40, and/or track the terms of such offers 42. The seller of the draft can choose to accept the offer with the most favorable terms. If a seller, or holder is unsatisfied with all offers for a draft that they posted for sale, they can decline all offers. The user may track every aspect of the making, negotiating and funding of such drafts in a transfer book 44.

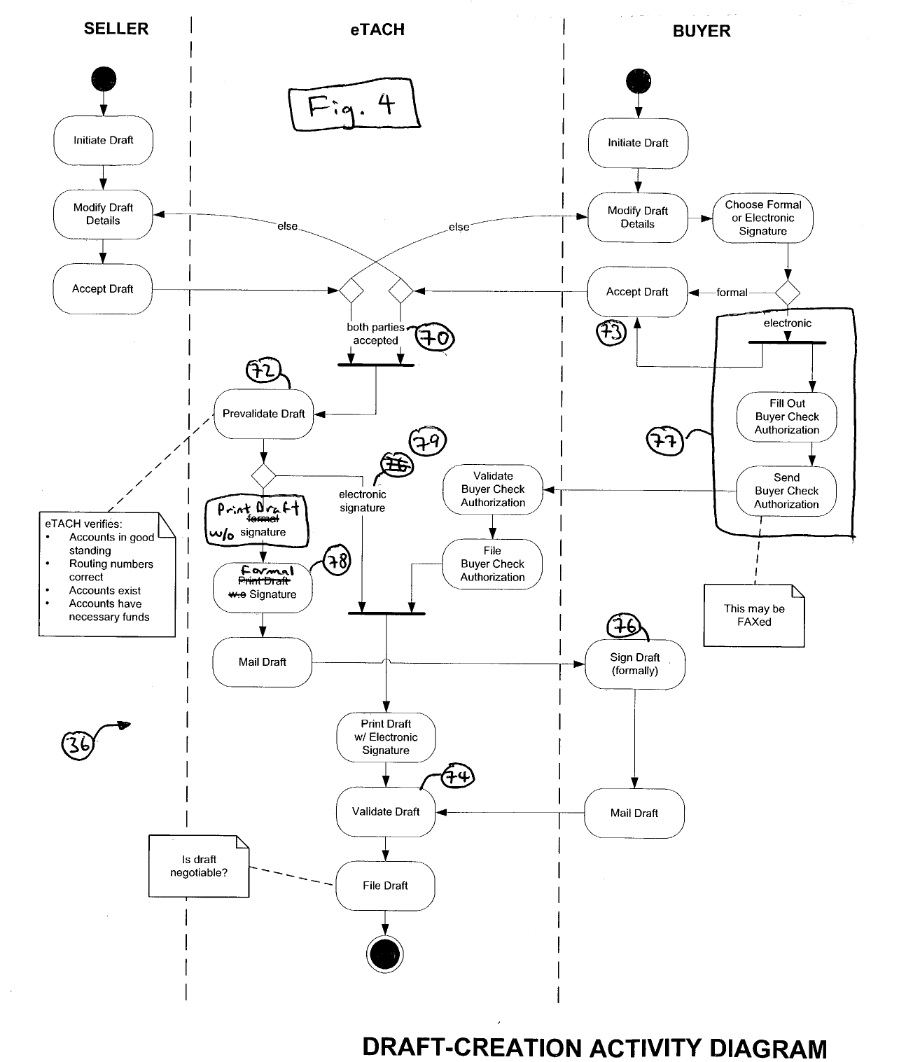

The draft making process (reference 36 of FIG. 1) is illustrated in FIG. 4. It is noted that once both the buyer and the seller accepts the draft 70, the draft is pre-validated by the system to make sure the buyer has an existing account in the specified bank, the routing numbers are correct, and that there are sufficient funds to cover the draft 72. Thus, the system captures and validates the draft and the terms of the draft. To validate the draft 74, once the buyer authorizes the terms of the draft 73, the buyer sign the draft physically 76 or electronically 77. In addition, the seller authorizes the terms of the draft electronically 79 or physically 78. In a further embodiment, the financial intermediary captures the entire process electronically, and records the process for electronic access by the users.

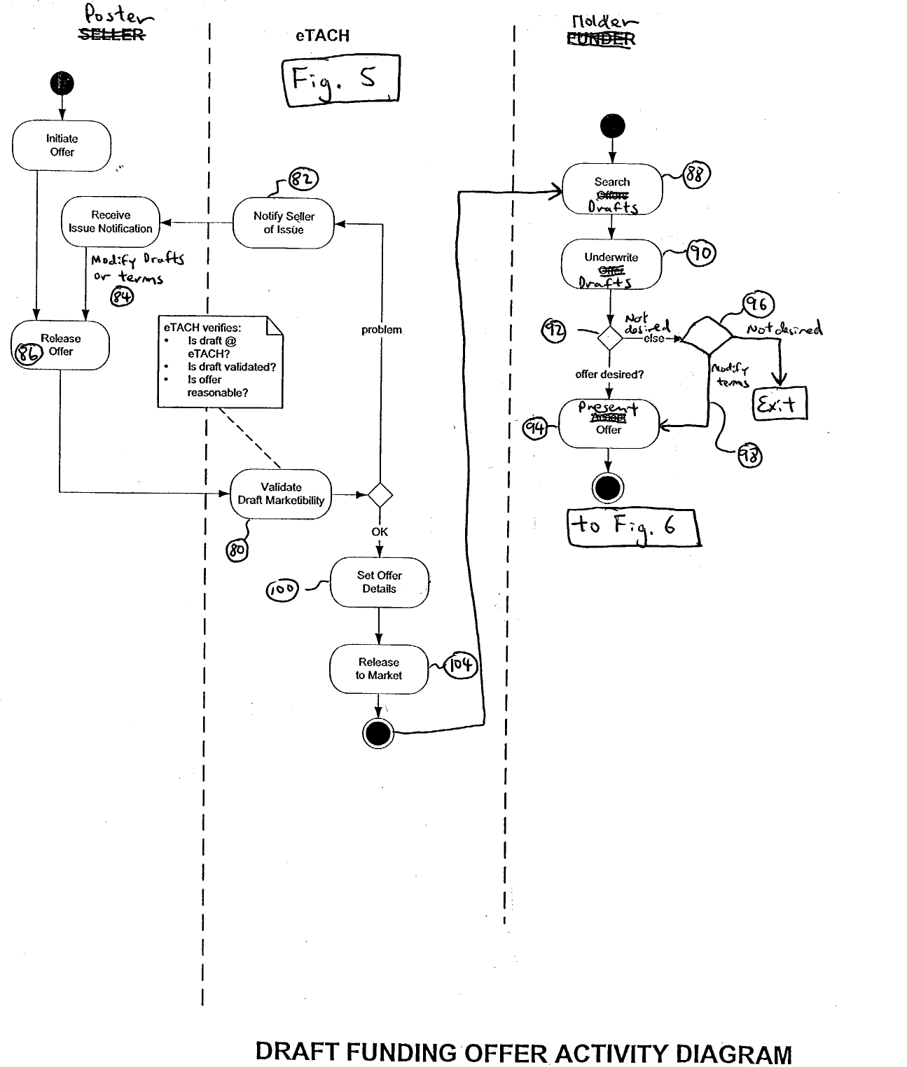

The details of the marketing of the drafts are illustrated in FIG. 5. When a poster (whether the poster is a seller or a holder) seeks to post the draft to the market 86, the marketability of the draft is validated 80, to determine whether or not a valid draft is in the file, and the terms are reasonable within the context of the standardized agreement. If there is a problem, the poster is notified 82 and the draft or the terms are modified 84, and posted again 86. If there are no problems, the details of the posting of the draft are set 100 and the draft is posted to the market 104.

On the holder side, the holder can search for drafts or may have been notified of the availability of a draft fitting its risk criteria 88. Generally, the holder will independently underwrite the transaction to determine the desirability of the draft and the appropriate discount 90. A decision is made as to whether or not the draft is desirable 92. If desirable, an offer is made for the draft 94. If not desirable, a decision is made as to whether the draft can be amended to the holder's satisfaction 96. If not, the holder exits from this particular transaction, and may return to step 88 to seek or receive notification of other posted drafts. If modifiable to the holder's satisfaction, the holder proposes modifications to the draft or the terms of the sale 98, and presents the modified offer 94.

To notify the holder of the availability drafts that fit the holder's risk criteria, at the marketability validation 80, the buyer and seller risk profiles are scored. Note that when the offer details are set 100, it may or may not be acceptable to the market, so that the details may be modified by the combined effort of the poster, the financial intermediary and the holder to fit the draft within the standardized agreement and to make the draft more desirable to holders. For example, the poster may initially seek to sell the draft as non-recourse, while the holder may insist upon purchasing the draft with recourse. Other terms that are negotiable may include such terms as the percent reserves, the cap rate, the percentage of the transaction that the holder wish to purchase.

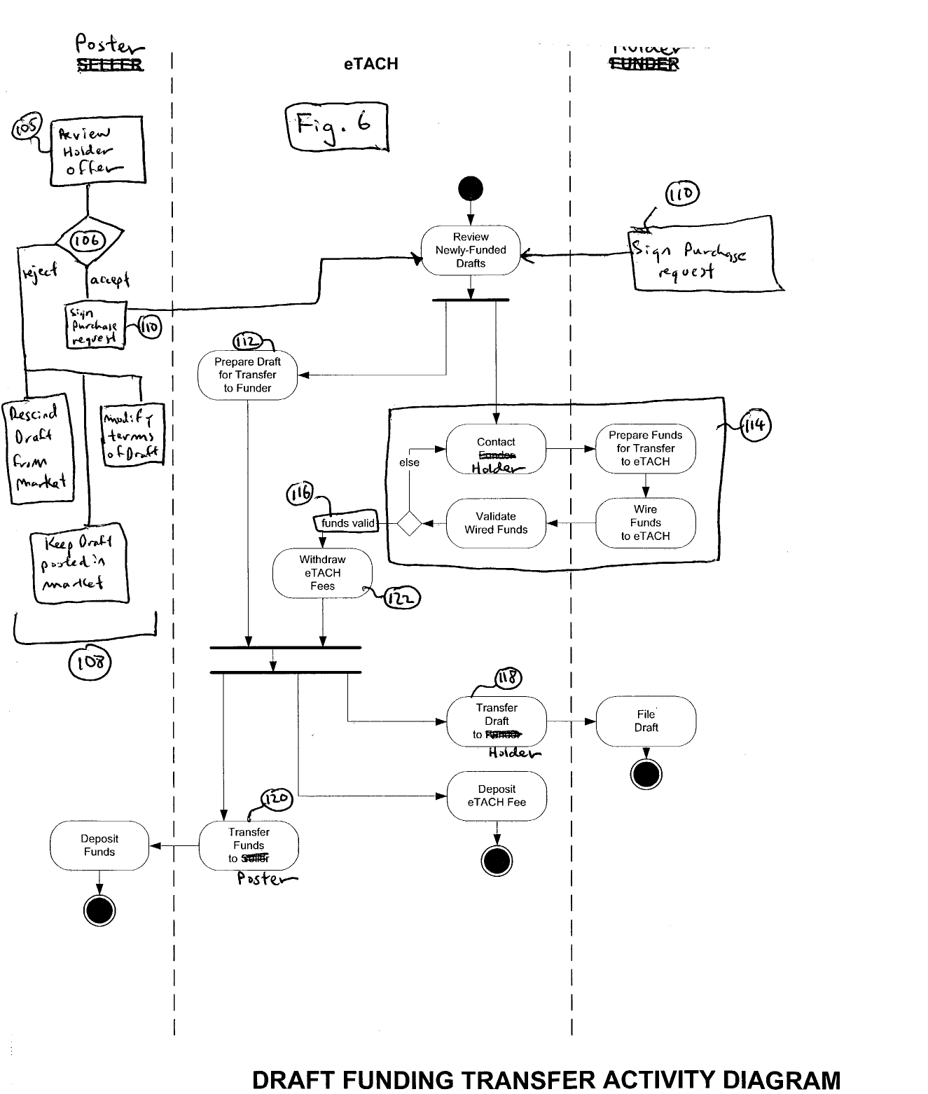

The details of the finalization of a sale of the draft is illustrated in FIG. 6. When the poster receives an offer 105, the poster can accept or reject the offer 106. If the poster rejects the offer, the poster may rescind the draft from the market, maintain the unmodified draft in the market, or modify the draft for re-posting 108. If the poster accepts the offer, a purchase request is signed by the poster and the holder 110. Alternatively, duplicate requests are signed by the poster and the holder. The financial intermediary reviews the transaction and prepare the draft for transfer to the holder 112. The financial intermediary also contacts the holder for the transference and validation of funds for the transaction 114. Once the funds are validated 116, the draft is transferred to the holder 118 and the funds are transferred to the poster 120. Optionally, the transaction fees are withdrawn from the funds prior to sending the balance to the poster 122.

Optionally, the system may accommodate a situation in which a buyer and a seller seeks to enter a transaction, but only one of the seller and the buyer is enrolled in the system. The registered user may enter the relevant information of the transaction into the system as illustrated in FIG. 1. In addition, the registered user may enter the relevant information for the unregistered partner 59 including any contact information. With this information, the system may notify the unregistered partner of the entry of the transaction and the need for the partner to registered for the transaction to proceed through the system.

If the user is a holder, the user may also access the financial information of the seller and the buyer in the transaction. The holder may use the information to assist in underwriting the drafts. Moreover, when the user enters draft tracking section 34, the system may also access the user's account information 46, including the account holder's estimated risk profile 48. That risk profile is matched to the risk criteria of enrolled holders 50, and if a draft is made or held by the user is posted for sale, the system can notify holders with matching risk criteria of the availability of a draft with the appropriate risk profile 52. Holders can also browse through the posted drafts to seek risk profiles that do not match their stated risk criteria exactly 54. Once a desired draft is found, the holder can participate in setting the terms 56 of the sale of the draft, including the discounted value 58 of the sale.

A system according to invention comprises an information storage system, a processor and a communication portal for users to input or extract information and for the system to communicate with the users. The information storage system comprises a database that stores data entered by the use through the communication portal. The information storage system also stores data and documents used by the system. Examples include the standardized document that is retrieved for execution by the users that seeks to enroll into the system. While expressed as a single information storage system, the information system can consist of a number of different information storage devices that are directly linked together, are separately linked to the system, or a combination thereof.

During enrollment, the processor is capable of matching the enrollment information to determine whether or not the user or the user's company already has an account. In addition, the processor can retrieve the information entered by the user into the database to process the commercial transactions. The system may tag the user to associate the user with a particular company. The processor may retrieve the company information to authenticate the financial data, and to assign a risk profile for the participant. The system is accessed through the communication portal by the users for entry of data necessary for making and negotiating drafts. Such data include credit lines, bank accounts, credit criteria, etc.

The system is also set up for accepting fees, transferring funds, establishing a line of credit from the participants, and processing transactions between the participants. Optionally the system may automatically validate the various steps of the transaction by, for example, contacting a valid check or draft maker, or verifying the sufficiency of funds. In addition, the system may stamp documents with an authenticating identifier or compare written signatures in signed documents. Further, the system may contact the person(s) authorized to make the drafts to verify that a draft was properly authorized.

When the users seek to make and market the drafts, the relevant information is entered and stored. The system access the information to perform the validation procedures. Part of the validation will provide for authorization by the parties, or cancellation by one or more of the parties. In addition, the system verifies that the parties have executed the standardized agreement, and that the buyer's authorized maker verifies the making of the draft. Eventually, the system has the buyer signs the draft physically or electronically and validates the executed draft. The system may tag the executed draft as marketable at this point, and notifies the seller that the draft is marketable. Alternatively, the system may tag the executed draft as marketable only after the seller attempts to post the draft to market. governing

The system also provides for tracking the holder offers to tag the highest bid. The system may notify the poster of the bids for acceptance, or allow the poster to view the bids. Upon the poster's acceptance, the system may automatically create purchase requests, detailing the terms of the transaction for the poster and for the winning holder.

The system provides for notifying holders that drafts that fit the holders' risk criteria is made available. Alternatively, holders may enter the system to search fo drafts of interest. The system may utilize numerous methods to grade the risk profiles of the parties and the drafts. No method to grade the risk profiles is fool-proof, and the one used by the system provides a guide and does not replace the underwriting done by the holders. Optionally the system tracks the grade with the eventual risk value achieved by the market to modify the grading method to better reflect the market value.

Once a draft transaction is approved, the system provides for the transfer of the funds from the holder to the poster, and for the transfer of the draft to the holder. Optionally, the processor automatically debits the processing fee before transferring the balance of the transaction value to-the poster. The system also optionally establishes and keeps a transfer book for the issuer and any subsequent holder, to detail the making, negotiation and maturity of such drafts.

Upon the due date of the draft, the draft owner may present the draft to the designated bank or submit the draft into the banking system for collection. The system may be set up to notify the draft owner of the maturity of the draft, or alternatively, the system may automatically identify the draft owner, and electronically debit the value of the draft from the designated bank, and transfer the amount to the draft owner's bank (less any processing fees). In addition, when the value of the transaction is too large for a single holder, or if the holder seeks to disperse the risk of the transaction among more participants, the draft may be fractionated into multiple drafts held by multiple holders.

I claim:

1. A standardized agreement comprising:
a buyer section, that when executed by a buyer, provides for the buyer to make an irrevocable draft for the payment of a specified amount, on a specified date, at a specified financial institution;
a seller section, that when executed by a seller, provides for the seller to accept the draft as consideration for providing goods, services or a combination thereof to the buyer, such that the seller may optionally post the draft for sale; and
a holder section, that when executed by a holder, provides for the holder to optionally purchase the draft when the seller posts the draft for sale,
wherein the terms of the standardized agreement provide that the draft may be submitted for collection at the specified financial institution free of any commercial dispute between the seller and the buyer.

2. The agreement according to claim 1 that further provides for a financial intermediary that serves in a administrative capacity to manage and supervise the transactions arising therefrom, and provides for the financial intermediary to provide an electronic forum for making, marketing, negotiating and settling the drafts.

3. A virtual commercial forum comprising:
a user enrollment section for a user to enter the commercial information of the user to enroll as a seller, a buyer, a holder or a combination thereof; and
a tracking section comprising a draft making section for a buyer in a commercial transaction to make an irrevocable draft payable to a seller, a draft marketing section for a draft owner to post a draft for liquidation and for holders to view and optionally bid on the posted draft, and a draft funding section for a draft buyer to transfer funds for the purchase of a draft to a draft owner,
wherein the forum does not permit the user to access the draft accessing section unless the user executes the standardized agreement of claim 2.

4. The forum according to claim 3, further comprising a processing section that determines a score for a first risk profile for the buyer and a score for a second risk profile for the seller to determine a risk profile of the draft.

5. The forum according to claim 4, further comprising: a risk matching section that matches the risk profile of the draft with a risk criteria provided by a holder, and notifies the holder when a match is found.

6. A commercial financing method comprising:
executing a standardized agreement among a buyer, a seller and a holder that provides for the buyer to make an irrevocable draft payable for a specified amount, at a specified date by a specified financial institution, for the seller to accept the draft as consideration for providing goods or services to the buyer, such that the seller may optionally post the draft for sale to the holder, for the holder to optionally purchase the draft when the seller posts the draft for sale, and for the draft to be submitted for collection free of any dispute between the buyer and the seller.

7. The method according to claim 6, further comprising the steps of:
the buyer making the draft payable to the seller; and
the seller selling the draft to the holder at a discounted value from the specified amount.

8. The method according to claim 7, wherein on or after the specified date, the holder submits the draft to a banking system for payment by the specified bank.

9. The method according to claim 7, further comprising step of the holder selling the draft to a second holder at a second discounted value from the specified amount.

10. The method according to claim 6, wherein the agreement is executed by multiple holders, and the seller posts the draft for sale to any one of the holders, and sells the draft to the holder that provides a highest price for the draft.

11. The method according to claim 10, wherein the seller posts the draft for sale to any one of the holders in an electronic forum.

12. The method according to claim 10, wherein the standardized agreement provides for a financial intermediary that serves in an administrative capacity to manage and supervise all transactions arising therefrom, and the financial intermediary provides an electronic forum for enrolling the buyer, the seller and the holders, and for making, negotiating, marketing and settling the drafts.

13. The method according to claim 12, further comprising the financial intermediary validating that the draft complies with the terms of the standardized agreement, and verifying that the buyer has an account having sufficient funds to cover the draft with the specified financial institution, and that the buyer has authorized the making of the draft.

14. The method according to claim 13, further comprising the financial intermediary calculating the risk profile of the buyer and the risk profile of the seller to determine the risk profile of the draft, and matches the risk profile of the draft to a risk criteria of a holder to notify the holder of the availability of the draft.

15. The method according to claim 13, further comprising the financial intermediary validating a transference of the draft, and transferring funds from a draft buyer to a draft owner, and recording the transfer in a transfer book.

16. A system of commercial financing comprising a processor, an information storage system, an electronic clearinghouse and a communication portal, wherein:
the communication portal provides access to the processor and information storage system by a user selected from the group consisting of a buyer, a seller, a holder and a combination thereof, for entry of relevant information of the user selected from company information, financial information and combinations thereof for entry into a database;
the information storage system stores a standardized agreement having a buyer section, a seller section and a holder section that provides for a buyer to make an irrevocable draft for payment of a specified amount, on a specified date, at a specified financial institution, for a seller to accept the draft as consideration for providing goods or services to the buyer that is optionally sellable by the seller to a holder, and for a holder to optionally buy a draft that is posted by the buyer for sale,
the electronic clearing house allows the user to perform a commercial activity selected from the group consisting of making, negotiating, marketing and settling of the irrevocable drafts, and
the system does not permit the user to access the electronic clearing house unless the user executes the standardized agreement.

17. The system according to claim 16, wherein banking information of the user is stored in the database, and is capable of being accessed by the processor to automatically transfer funds into or out of the user's bank in the course of a commercial activity selected from the sale of a draft, the purchase of a draft and the settling of a draft.

18. The system according to claim 16, wherein the processor is capable of accessing user information to calculates a risk profile of a buyer and a seller to calculate a risk profile of a draft made by the buyer to the seller.

19. The system according to claim 16, wherein the system provides access by a user that is a holder to the user information of a seller and a buyer to allow the holder to underwrite a draft made by the buyer to the seller.

20. The system according to claim 18, wherein the system notifies a user that is a holder that a draft with a risk profile that fits the holder's risk criteria is available for sale.
